(19) United States
(12) Patent Application Publication
(10) Pub. No.: US 2018/0053193 A1
(43) Pub. Date: Feb. 22, 2018

(54) SYSTEM AND METHOD FOR REAL TIME FINANCIAL INSTITUTION BUSINESS INTELLGENCE AND CUSTOMER RELATIONSHIP MANAGEMENT

(71) Applicant: JPMORGAN CHASE BANK, N.A., (US)

(72) Inventors: Donna Cayetano CHARBONNEAU, Powell, OH (US); Autumn Brandy DeSellem, Columbus, OH (US)

(73) Assignee: JPMORGAN CHASE BANK, N.A., New York, NY (US)

(21) Appl. No.: 13/801,225

(22) Filed: Mar. 13, 2013

Related U.S. Application Data
(60) Provisional application No. 61/756,613, filed on Jan. 25, 2013.

(51) Int. Cl. G06Q 30/00

(52) U.S. Cl. CPC G06Q 30/016

(57) ABSTRACT

A system and method is provided that provides actionable intelligence information for financial institution personnel. The method and system may be both proactive and preemptive to manage sales and customer flow, and may be designed for use within a branch office or other physical location of a financial institution. A series of interfaces may be used to view, manage, and take action on the intelligence information. A portable electronic device may be used to interface with the system. The interface may be customizable based on a number of factors such as, but not limited to, store hierarchy, role, and objective.

### CROSS-REFERENCE TO RELATED APPLICATIONS

This patent application claims priority to and the benefit of U.S. Provisional Patent Application No. 61/756,613, filed Jan. 25, 2013. The contents of this priority application is hereby incorporated by reference herein in its entirety.

### BACKGROUND

Financial institutions provide financial services to customers. Many of these services are provided at branch office locations. Managers, other supervisory personnel, as well as employees, at these branch office locations typically do not have access to real time information or intelligences regarding customer service issues and equipment problems that are occurring in the branch location.

These and other deficiencies exist.

### SUMMARY OF THE PREFERRED EMBODIMENTS

An exemplary embodiment includes a method having the following steps: providing an electronic user interface on a computing device, wherein the electronic user interface comprises a first screen comprising at least one option and the interface is tailored to a financial institution; receiving, electronically, a selection of an option from the at least one option on the first screen; providing, electronically, a second screen in response to the selection of the option; receiving, from one or more servers, real time data based on the selection of the option wherein the real time data relates to the operation of a branch of a financial institution based on the option; and causing the real time data to be displayed on the second screen.

In other exemplary embodiments, the preceding method may be performed using a system with a processor and a memory comprising computer-readable instructions which when executed by the processor cause the processor to perform the method steps.

These and other embodiments and advantages of the invention will become apparent from the following detailed description, taken in conjunction with the accompanying drawings, illustrating by way of example the principles of the various exemplary embodiments.

### BRIEF DESCRIPTION OF THE DRAWINGS

FIG. 1 is a diagram of a system in accordance with an exemplary embodiment.

FIG. 2 is a flow chart of a method of using a computing device in accordance with an exemplary embodiment.

FIG. 3 is a flow chart of a method for selecting options on a computing device in accordance with an exemplary embodiment.

FIG. 4 is a depiction of an interface in accordance with an exemplary embodiment.

FIG. 5 is a depiction of another interface in accordance with an exemplary embodiment.

FIG. 6 is a depiction of another interface in accordance with an exemplary embodiment.

FIG. 7 is a depiction of another interface in accordance with an exemplary embodiment.

FIG. 8 is a depiction of another interface in accordance with an exemplary embodiment.

FIG. 9 is a depiction of another interface in accordance with an exemplary embodiment.

FIG. 10 is a depiction of another interface in accordance with an exemplary embodiment.

FIG. 11 is a depiction of another interface in accordance with an exemplary embodiment.

FIG. 12 is a depiction of another interface in accordance with an exemplary embodiment.

### DETAILED DESCRIPTION OF THE PREFERRED EMBODIMENTS

It will be readily understood by those persons skilled in the art that the embodiments of the inventions described herein are capable of broad utility and application.

Accordingly, while the invention is described herein in detail in relation to the exemplary embodiments, it is to be understood that this disclosure is illustrative and exemplary of embodiments of the invention are described to provide an enabling disclosure of the invention. Accordingly, the disclosure is not intended to be construed to limit the embodiments of the invention or otherwise to exclude any other such embodiments, adaptations, variations, modifications and equivalent arrangements. While the various embodiments of the present invention are described in the context of financial transaction/services devices and providing of financial services, the methods and systems described herein may be applied to other related industries who provide services involving interaction with customers as well as other industries that require real-time monitoring of information/data regardless of customer interaction. Exemplary embodiments may have broad applications for uses that require a form factor agnostic solution for real-time data and intelligence management.

The following descriptions are provided of different configurations and features according to exemplary embodiments. These configurations and features may relate to providing financial services through branch offices to customers. While certain nomenclature and types of applications/hardware are described, other names and application/hardware usage is possible and the nomenclature provided is done so by way of non-limiting examples only. Further while particular embodiments are described, it should be appreciated that the features and functions of each embodiment may be combined in any combination as is within the capability of one of ordinary skill in the art. The attached Figures provide additional details regarding the present invention. It should also be appreciated that these exemplary embodiments are provided as non-limiting examples only. Exemplary embodiments may be applicable outside of the financial services industry and may be adapted for use in a variety of other industries, particularly those that provide services to customers where the real time information provided by the systems and methods would be of value and assist in providing a more efficient customer service experience. The exemplary embodiments may be used outside of the financial services industries to provide a real-time data management solution, regardless of customer interaction requirements. Exemplary embodiments provide improved efficiency in both education, training, and management of information/data for employees and management personnel in a form factor agnostic system. The exemplary embodiment of various interfaces described herein may be modified to support these other applications and uses.

Financial institutions, as used herein, may include institutions that provide financial services to their members or customers. Financial institutions may include, but are not limited to banks, credit unions, trust companies, mortgage loan companies, insurance companies, investment banks, underwriters, and brokerage firms.

According to exemplary embodiments, a system and method may be provided that provides actionable intelligence to branch managers and other banking personnel. Exemplary embodiments are configured to provide a method and system that is proactive and preemptive to manage sales and customer flow. The system and method may be designed for use within a branch office or other physical location of a financial institution. The method may be implemented on a computer based platform. According to exemplary embodiments, a portable electronic device or a mobile device may be used as the interface portion of the system. The portable electronic device may be configured such that the system is not tied to a particular location and the portable electronic device can be moved between geographic locations. Exemplary embodiments are designed to be wireless and mobile. In some embodiments, the computer based platform may be tied to a particular location. Exemplary embodiments may further be customizable based on a number of factors such as, but not limited to, store hierarchy, role, and objective. It should be understood that a variety of computing platforms or combinations of different platforms may be used to implement exemplary embodiments as described herein.

Accordingly, exemplary embodiments may provide a system known as a “BranchView Board” (BvB) that provides financial institution branch personnel with a portable electronic device or a mobile device that helps them “run the floor”, by delivering actionable intelligence and real-time insight at the users fingertips resulting in a proactive, preemptive, and efficient environment. The mobile device may enable portable and rapid access to banking resources, such as, for example, those resources used most frequently. For example, the resources may include P&P (policies & procedures), PRG (product reference guide), Internal Checklists Self Control (ICSC), and “How to . . . ” tutorials. These resources may be provided on the mobile device for portability and rapid access. The mobile device may extend the alerting capability for self-service assets, such as, for example, the Self-Service Banking (SSB) Kiosks, Automated Teller Machines (ATM), and financial services devices associated with the financial institution. This alerting capability may thus move the interaction with the customer from behind the machine to front and mobile next to customer, as a result, prompting customer attention may be provided resulting in an improved customer/banker dynamic. The mobile device may provide the capability to view and act on prompts that have otherwise only been accessible through immobile fixtures/screens (on fixed desktop type computers). These prompts may provide key customer information and profile data. For example, the customer's name, accounts, and prior experiences may be provided to the banker while the customer is interacting with the banker and/or the financial services device. The mobile device may inform the branch management team and employees of the readiness and status of each of the branch's assets. For example, the status of each asset may be provided, such as whether it is offline, when help or service is arriving, and when an action needs to be taken, including details of the required action.

Exemplary embodiments may provide real time visibility into the health of branch assets, customer care and support, customer profile and opportunity, and key sales metrics and tools through one or more interfaces. Exemplary embodiments have a user interface that has a series of different displays and interface screens. A home screen is configured with different icons for the different features. According to exemplary embodiments these icons may include a health status icon, a customer care icon, a customer keys icon, and a tools icon. In some embodiments, a sales activity icon may be provided. The icons may be arrangeable on the screen. It should be appreciated that these icons may be customizable and the interface home screen may have more than four icons or less than four icons.

In some embodiments, the icons may be replaced by a toolbar with the options for selection. For example, the tool bar with the selections may be located at the upper portion of a display screen. The toolbar may have selections for health status, customer care, customer keys, and tools. The toolbar may have more or less options. The toolbar may be customizable.

Accordingly, exemplary embodiments provide a platform to implement systems and methods to enable a branch manager or other branch personnel to have real time access to intelligence and data regarding events occurring within a branch of the financial institution.

Examples of the available information and intelligence delivered by exemplary embodiments include the below. Each of the information/data described in the below example may be available/caused to be displayed by selecting an appropriate option on the interface according to exemplary embodiments.

Identifying customer that is swiping a card or logging into a self-service device, such as a financial services device or when a customer passes a designated threshold in a transaction or when a customer passes a designated location, such as by using geo-fencing. The geo-fencing may be actuated by sensing a mobile device associated with the customer. Other methods of sensing a customer may be used. The identifying information may include the customer name, a customer experience signal; a customer segment (e.g., core, high balance, etc.); a customer since date; and a last visit date or the customer.

A push alert for customer support during self-service transactions. These push alerts may include that a teller/banker needs to review a deposit or there is an interruption in transaction flows for a financial services device(s) requiring banker/staff attention due to maintenance issue or machine failure; e.g., receipt or cash jammed.

Transaction components to facilitate customer support when needed at financial services devices in a more seamless and dynamic manner may be provided. These components include: screen flow/share BvB; fully functional to complete check validation and negotiability review requirements; and incorporation of authentication requirements for banker/manager credentials.

Health/readiness status branch assets may be provided. This may include both customer facing and banker facing assets and devices (e.g., Self-Service Banking Kiosks, Instant Issue Printers, Teller Cash Recyclers, Tablets, ATMs, Banker Desktops, Workstations, etc.). It should be appreciated that the assets included may be those inside of the branch and those in the vestibule/drive-up portion (e.g., exterior to the branch). Alerts and information regarding asset availability and when action is needed, ticket status including vendor deployment timing; assets with chronic issues may be provided. Exemplary embodiments may leverage other systems used in monitoring assets and dispatching/monitoring technician support of these assets.

Quick access may be provided to: Policy & Procedures (P&P)—aid in coaching, performing checklists; Product Reference Guides (PRG)—aid in coaching including BMI (Branch Manager Involvement) discussions; Internal Control Self Check (ICSC)—check lists used; and various “How to” tutorials, such as, e.g., replenishing of supplies for an Instant Issue Device or other financial services device.

The information in these non-limiting, exemplary examples may be provided through a mobile device using the interfaces according to exemplary embodiments as described here.

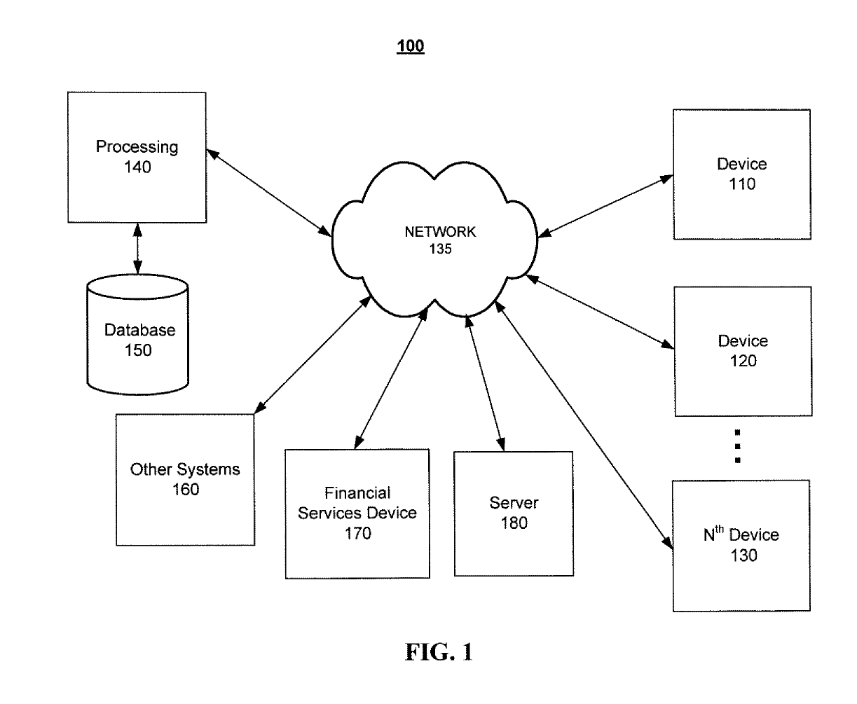

FIG. 1 is a system according to an exemplary embodiment of the invention. System 100 may provide various functionality and features associated with the program. More specifically, system 100 may include a device 110, a second device 120, and an Nth device 130, a network 135, a processing module 140, a database 150, other systems 160, a financial services device 170, and a server 180.

While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the modules or functionality associated with the modules may be supported by a separate application or platform. Other implementations and architectures may be realized. It should be appreciated that system 100 may be integrated into and run on a computer, which may include a programmed processing machine which has one or more processors. Such a processing machine may execute instructions stored in a memory to process the data and execute the methods described herein. System 100 may be integrated into and run on one or more computer networks which may each have one or more computers associated therewith.

As noted above, the processing machine executes the instructions that are stored in the memory or memories or persistent or non-transitory data storage devices to process data. This processing of data may be in response to commands by a user or users of the processing machine, in response to previous processing, in response to a request by another processing machine and/or any other input, for example. As described herein, a module performing functionality may have a processor.

According to exemplary embodiments, the system 100 may be configured to carry out the methods as described herein. The system 100 may have device 110 associated therewith. A second device 120 and an Nth device 130 may be further associated with the system 100. The devices 110, 120, and 130 may each be a processing machine. Each device 110, 120, and 130 may include software and/or modules to implement the methods described herein according to exemplary embodiments. Each device 110, 120, and 130 may provide processing, display, storage, communications, and execution of commands in response to inputs from a user thereof and respond to requests from the software and/or modules. It should be appreciated that even though the device 110, 120, and 130 may be referred to in the subsequent description, the system 100 may use any combination of these devices ranging from one device 110 to multiple devices 110, 120, and 130.

The devices 110, 120, and 130 may each serve as a client side. Each device 110, 120, and 130 may be a “fat” client, such that the majority of the processing may be performed on the client. Alternatively, the device 110, 120, and 130 may each be a “thin” client, such that the majority of the processing may be performed in the other components of the system 100 as best shown in FIG. 1. The devices 110, 120, and 130 may be configured to perform other functions and processing beyond the methods described herein. The devices 110, 120, and 130 may each be a part of a larger system associated with the financial institution. The devices 110, 120, and 130 may be multi-functional in operation. The devices 110, 120, and 130 may each support the operation and running of one or more applications or programs.

Each device 110, 120, and 130 may have a display and an input device associated therewith. The display may be monochrome or color. For example, the display may be a plasma, liquid crystal, or cathode ray tube type display. The displays may be touch screen type displays. The devices 110, 120, and 130 may have more than one display. The multiple displays may be different types of displays. The display may have sub-displays there on. For example, the device 110, 120 and 130 may have a large display surface. The display for the user interface may occupy a portion or less than the whole of the large display surface.

The input device may be a single device or a combination of input devices. For example, the input devices may include a keyboard, both full-sized QWERTY and condensed, a numeric pad, an alpha-numeric pad, a track ball, a touch pad, a mouse, selection buttons, and/or a touch screen. As described above, the display may serve as an input device through using or incorporating a touch screen interface. The devices 110, 120, and 130 may include other devices such as a printer and a device for accepting deposits and/or dispensing currency and coins.

The device 110, 120, and 130 may have one or more cameras, optical sensors, or other sensing devices. The sensors may be computer controlled and may capture digital images.

According to some embodiments, the devices 110, 120, and 130 may be portable electronic devices or mobile electronic devices. The user may interact with the portable electronic device through various input means (not shown). For example, the portable electronic device may have a display screen to convey information to the user. The display may be a color display. For example, the display may be a Liquid Crystal Display (“LCD”). The portable electronic device may have one or more input devices associated with it. For example, the portable electronic device may have an alpha-numeric keyboard, either physical or virtual, for receiving input. The portable electronic device may have a QWERTY style keyboard, either physical or virtual. The portable electronic device may have a pointing device associated therewith, such as, for example, a trackball or track wheel. The portable electronic device may receive inputs through a touch screen or other contact interface. In some embodiments, gesture based input may be used. A combination of input types may used. As described above, the portable electronic device may have communication capabilities over both cellular and wireless type networks to transmit/receive data and/or voice communications.

The portable electronic device, by way of non-limiting examples, may include such portable computing and communications devices as mobile phones (e.g., cell or cellular phones), smart phones (e.g., iPhones, Android based phones, or Blackberry devices), personal digital assistants (PDAs) (e.g., Palm devices), laptops, netbooks, tablets, or other portable computing devices. These portable electronic devices may communicate and/or transmit/receive data over a wireless signal. The wireless signal may consist of Bluetooth, Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and/or systems suitable for transmitting and receiving data from the portable electronic device, The portable electronic device may use standard wireless protocols which may include IEEE 802.11a, 802.11b, 802.11g, and 802.11n. Such portable electronic devices may be Global Positioning System (GPS) capable. GPS is a satellite based system which sends a signal allowing a device to define its approximate position in a coordinate system on the earth. That is, the portable electronic device may receive satellite positioning data and display the location on the earth of the portable electronic device using GPS. Other location systems may be used. The portable electronic device may include one or more computer processors and be capable of being programmed to execute certain tasks.

The device 110, 120, and 130 may establish communications with other parts of the system 100 over a network 135. Upon successful initiation of communications between the and the network 135 and another part of the system 100, such as, for example, processing 140 and database 150, data may be exchanged between device 110, 120, and 130 and the particular element over the network 135. Data may be transmitted from device 110, 120, and 130. Data may be transmitted from the other part of the system 100 to the device 110, 120, and 130.

The devices 110, 120, and 130 may have a log-in device associated therewith. The log-in device may be used to allow access to the device. The log-in device may require a particular input or it may accept a combination of inputs. The input may serve as an authentication of the user to the device 110, 120, or 130 and, in some embodiments, the system 100 in general. Various authentication or log-on systems and methods may be used. For example, these methods and systems may include entering a password or PIN (Personal Identification Number) or using a card to log-on, either via swiping the card through a reader, such as a magnetic stripe reader or a smart chip reader, or through a radio frequency system (which may require that the card be placed in proximity to an appropriate reader (i.e., a contactless system), such as, for example, RFID (Radio Frequency Identification) or NFC (Near Field Communications). It should be appreciated that the card may include a combination of a magnetic stripe, a smart chip, and radio frequency. Further, the use of the card is exemplary only and the card may include fobs, stickers, and other devices. Biometrics may be used, such as fingerprints, facial recognition, speech recognition, palm vein scan, or retinal scan. A combination of these systems may be used. Biometrics may be used in addition to other log-in methods and systems.

The devices 110, 120, and 130 may be communicatively coupled to the network 135. Accordingly, the devices 110, 120, and 130 may be geographically dispersed. Conversely, two or more of devices 110, 120, and 130 may be located in close proximity. For example, the devices may be located within or near a branch office of the financial institution. Wherever the location of the device 110, 120, and 130, it may still be able to communicatively couple with the network 135 and the components of the system 100.

In some embodiments, the devices 110, 120, and 130 may be other types of computing platforms, such as, for example, a desktop computer or a laptop computer. The devices 110, 120, and 130 may be a combination of computing devices.

The devices 110, 120, and 130 may each be remotely accessible. Remote access may be used to configure, troubleshoot, and wipe the contents of the device, for example.

Network 135 may be a computer based network, with one or more servers and/or computer processors. For example, network 135 may be the Internet or a network connected to the Internet. The network 135 may be a satellite or cellular based network. Information and data may be exchanged through the network 135 between the various components of the system 100. In alternative embodiments, the network 135 may be a local area network within the financial institution that may be connected to or interface with the Internet. It should be appreciated that the network 135 may be a combination of local area networks, wide area networks, and external networks, which may be connected to the Internet.

The processing module 140 may be communicatively coupled to the network 135. The processing module 140 may perform operations associated with the establishment, configuration, and application of the programs accordingly to exemplary embodiments. The processing module 140 may consist of one or more servers and/or general purpose computers, each having one or more computer processors associated therewith.

The processing module 140 may have a database 150 communicatively coupled thereto. The database 150 may contain data and information used by the system 100. For example, the database 150 may store account data for financial institution account holders as well as other data associated with the financial institution. Additional information maybe contained therein related to the operation and administration of the system 100. The database 150 may include any suitable data structure to maintain the information and allow access and retrieval of the information. For example, the database may keep the data in an organized fashion. The database 150 may be a database, such as an Oracle database, a Microsoft SQL Server database, a DB2 database, a MySQL database, a Sybase database, an object oriented database, a hierarchical database, a flat database, and/or another type of database as may be known in the art that may be used to store and organize rule data as described herein.

The database 150 may be stored in any suitable storage device. The storage device may include multiple data storage devices. The multiple data storage devices may be operatively associated with the database 150. The storage may be local, remote, or a combination thereof with respect to the database. The database 150 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CWS), network attached storage (NAS), or a network file system (NFS). The database may have back-up capability built-in. Communications with the database 150 may be over a network, such as the network 135, or communications may be over a direct connection between the database 150 and the processing module 140, as depicted in FIG. 1. Data may be transmitted and/or received from the database 150. Data transmission and receipt may utilize cabled network or telecom connections such as an Ethernet RJ15/Category 5 Ethernet connection, a fiber connection, a traditional phone wireline connection, a cable connection or other wired network connection. A wireless network may be used for the transmission and receipt of data.

The system 100 may have other systems 160 associated therewith. These other systems 160 may include various data collection and support systems used by the financial institution to carry out a variety of functions. The systems 160 may include equipment and other assets of the financial institution, such as equipment of a particular branch.

The system 100 may include a financial services device 170. The financial services device 170 may be more than one financial services device. The financial services device may be a transaction device for conducting transactions with the financial institution. Financial services devices, as used herein, may include machines, kiosks, and stations for performing financial services transactions. These devices include, but are not limited to, automated teller machines (“ATMs”), personal teller machines (“PTMs”), financial self-service devices, financial services kiosks, financial transaction devices, portable electronic devices, money machines, cash machines, bank machines, and bancomats.

For example, the financial services device 170 may be an ATM. In some embodiments, the financial services device 170 may be a portable or hand-held computing or electronic device, or other type of computing device, that has the described functionality. For example, the financial services device 170 may be a tablet computing device. The tablet computing device may be used to perform transactions similar or the same as those at a traditional ATM. Additional devices may be coupled to the portable or hand-held computing device to perform various functions such as accepting deposits or dispensing currency.

The financial services device 170 may provide various functionality and features for conducting transactions with the financial institution. For example, the financial services device 170 may be capable of accepting deposits and mixed deposits, withdrawals and multi-denomination withdrawals, coin deposits/withdrawal, check cashing, statement printing, wires, bill pay and check printing. It should be appreciated that the financial services device 170 may be capable of other functions and features. Transactions may be supported relating to other financial institutions. For example, the device may be part of a network associated with more than one financial institution. The network may be managed by a third party.

The financial services device 170 may have a log-in device associated therewith. The log-in device may be used to allow access to the device. The log-in device may require a particular input or it may accept a combination of inputs. The input may serve as an authentication of the user to the financial services device 170. Various authentication or log-on systems and methods may be used. For example, these methods and systems may include entering a password or PIN (Personal Identification Number) or using a card to log-on, either via swiping the card through a reader, such as a magnetic stripe reader or a smart chip reader, or through a radio frequency system (which may require that the card be placed in proximity to an appropriate reader (i.e., a contactless system), such as, for example, RFID (Radio Frequency Identification) or NFC (Near Field Communications). For example, the blink® system may be used. It should be appreciated that the card may include a combination of a magnetic stripe, a smart chip, and radio frequency. Further, the use of the card is exemplary only and the card may include fobs, stickers, and other devices. Biometrics may be used, such as fingerprints, facial recognition, speech recognition, palm vein scan, or retinal scan. A combination of these systems may be used. Biometrics may be used in addition to other log-in methods and systems.

The financial services device 170 may be communicatively coupled to the network 135. Accordingly, the financial services device 170 may be geographically dispersed. Conversely, two or more of devices financial services device 170 may be located in close proximity to provide a cluster of devices for customer use. For example, the financial services device 170 may be located within or near a branch office of the financial institution. The financial services device 170 may be located in other locations such as retailers or merchants. According to some embodiments, the financial services device 170 may interact with the devices 110, 120, or 130. Through the device 110, 120, or 130, the financial services device 170 may interact with the server 180 or other parts of the system 100.

It should be appreciated that the server 180 may interact with other parts of the system 100, such as the devices 110, 120, and 130, as well as the processing module 140 and the other systems 160. The server 180 may be a single server or it may be multiple servers. The server 180 may server a variety of roles in the system 100.

The server 180 may have one or more storage devices associated therewith. The storage may be local, remote, or a combination thereof with respect to the server 180. The storage may utilize a redundant array of disks (RAID), striped disks, hot spare disks, tape, disk, or other computer accessible storage. In one or more embodiments, the storage may be a storage area network (SAN), an Internet small computer systems interface (iSCSD SAN, a Fiber Channel SAN, a common Internet File System (CIFS), network attached storage (NAS), or a network file system (NFS). The storage may have back-up capability built-in. The back-up capability of the storage may be used to archive image data for later use. The back-up capability may be used for recovery of data in the event of a failure of the storage.

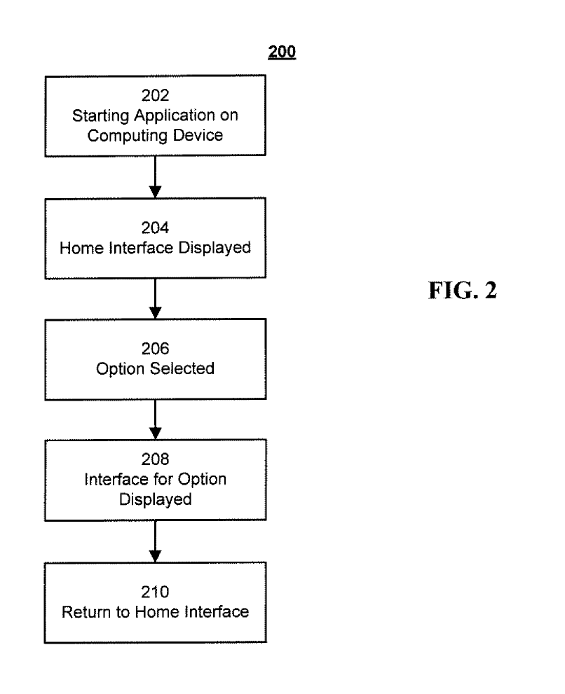

FIG. 2 depicts a flow chart of a method of according to exemplary embodiments of the invention. Exemplary method 200 is provided by way of example, as there are a variety of ways to carry out the methods disclosed herein. The method 200 as shown in FIG. 2 may be executed or otherwise performed by one or a combination of various systems, such as the computer implemented system 100 depicted in FIG. 1. Each block shown in FIG. 2 represents one or more processes, methods, and/or subroutines carried out in the exemplary method 200. Each block may have an associated processing machine or the blocks depicted may be carried out through one processor machine.

At block 202, an application is started on a computing device. The application may be an application for real time intelligence management as described herein. The computing device may be a portable computing device or a non-portable computing device. According to exemplary embodiments, the computing device may be a tablet computing device. The application may be started or initialized by a user. In some embodiments, the starting may not be required as the application may be the only application present on the computing device. Thus, in those embodiments, this step may be optional.

The starting of the application may involve a log in process. The log in process may ensure that only authorized users may access the application. The log in process may be combined with a log in to the computing device itself; that is, a user may log into the computing device and be granted access to the application. The log in may be conducted using any number of methods. For example, biometrics or a username/password may be used. A combination of log in methods may be used. For example, biometrics and an entry code may be required.

At block 204, a home interface is displayed. The home interface may be displayed following the starting of the application. In embodiments where the application is the only application present on the computing device, the home interface may be displayed upon startup of the computing device. The home interface may serve as an events board that provides a summary of events, alerts, and notification present on each of the options according to exemplary embodiments. The home interface may be a separate display or may incorporate the options described herein. The home interface may have a link or toolbar to go to the options described herein.

At block 206, an option may be selected. The option may be selected by the user. The home interface may present one or more options to the user. In some embodiments, the options may be on a separate interface from the home interface. Each option may provide access to additional features, functions, and/or data. According to exemplary embodiments, the home interface may have four options. Each option may be represent by an icon and/or text describing the option. Selection of the icon may be performed in a variety of manners. For example, the computing device may use a touch screen interface and/or may have a pointing device.

At block 208, following selection of the option, another interface screen may be displayed for the option. It should be appreciated that each interface screen may provide additional options that, when selected, cause additional interfaces to be displayed.

At block 210, the home interface is displayed. Upon completion of actions within the option, the user may select a home interface return option which causes the home interface to be displayed.

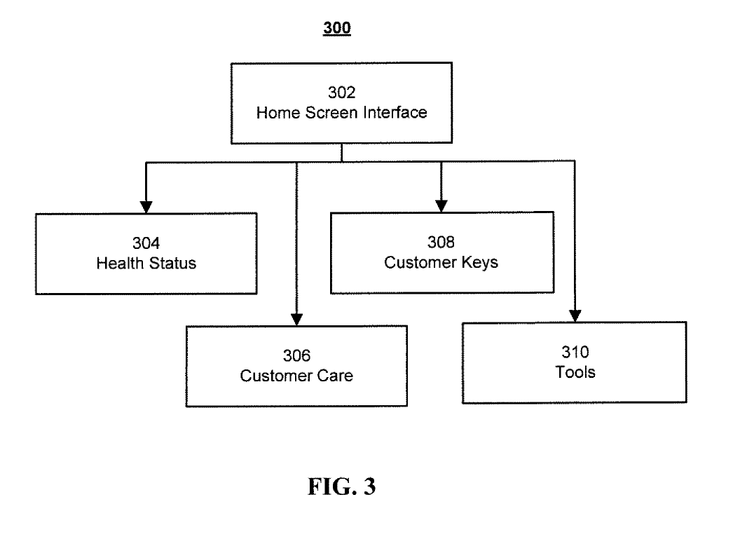

FIG. 3 depicts a flow chart of a method of according to exemplary embodiments of the invention. Exemplary method 300 is provided by way of example, as there are a variety of ways to carry out the methods disclosed herein. The method 300 as shown in FIG. 3 may be executed or otherwise performed by one or a combination of various systems, such as the computer implemented system 100 depicted in FIG. 1. Each block shown in FIG. 3 represents one or more processes, methods, and/or subroutines carried out in the exemplary method 300. Each block may have an associated processing machine or the blocks depicted may be carried out through one processor machine.

The method 300 depicts an option selection tree from the home interface. The method 300 may depict the options available for selection at block 206 in the method 200 described above. It should be appreciated that the options in the method 300 are exemplary and meant to be non-limiting.

At block 302, a home screen interface is displayed. On the home screen interface may be one or more options. For example, the home screen interface may have four options displayed. The options may include health status at block 304, customer care at block 306, customer keys at block 308, and tools at block 310. Selection of each option may cause a subsequent interface to be displayed. Each option may be displayed as an icon and/or text on the home interface. Selection of the icon may be performed in a variety of manners. For example, the computing device may use a touch screen interface and/or may have a pointing device.

The health status 304 may provide information on asset readiness at the branch. This may include both customer-facing assets, such as ATMs and other customer used devices, and banker/teller-facing assets, such as workstations, printers, and servers. The health status 304 may allow a user to interface with the customer-facing and the banker/teller-facing assets. Through this interface various aspects of the asset may be controlled or modified. This direct asset interfacing may allow for troubleshooting and correction of identified problems or maintenance issues. For example, the health status 304 may allow an interface with an ATM or other financial services device. Various settings of this financial services device may be modified such as cash management and setting of minimum and maximum cash dispensing by denomination. The health status 304 may provide access to schematics, blueprints, and/or layout of the branch location. These schematics, blueprints, and/or layouts may be interactive and may provide indication of problem areas.

The customer care 306 and the customer keys 308 may provide customer service information. The information may include the status of each customer known to be in the branch and what business they are conducting, as well as customer complaints and problems. Historical customer data may be included also. The customer care icon may enable customer scheduling and prioritization as well as management of staffing and other resources focused on customer service and interaction.

The customer care 306 may include tools to enable two way communication between the platform holder and staff in the branch as well as communication with customers. The customer care 306 may have an expert link or telepresence capability. For example, the customer care 306 may use a digital imaging device associated with the computing device. The digital imaging device may provide for a video link with another user either within or external to the branch. In this manner, direct video communication can occur. The customer care 306 may further provide access to various alerts regarding customer interaction in the branch. Customer profile information may be displayed.

The customer keys 308 may provide sales information to offer the customer a relevant financial services product or other offer. The customer keys 308 may provide a smart queue to provide customer enabled task management and transparency in tasks while in the branch. The customer keys 308 may provide information to enable a user to interact with a customer and have all the necessary information available to facilitate the interface such as the customer profile and other relevant information about the customer including suggestions for a targeted greeting and relevant conversation to have with the customer.

As part of the customer care 306 and/or the customer keys 308 options, there may be additional features, functions, and capabilities. For example, customer profiles may include an offer library. This library may include a listing of offers and other correspondence between the financial institution and the customer. Thus, a listing of all the touches (contact) with the customer may be document and stored for use. This may include both mail and electronic communications as well as visits to branches. This enables the financial institution personnel, particularly the users of the interface to know the customer and what has been sent to them as well as prior actions taken by the customer at branches. For example, a customer may enter a branch and state they have received an offer and wish to redeem it. The customer may not have the offer with them. The interface may allow the offer information to be retrieved and validated. Additionally, the redemption of the offer may be input into the interface to provide further tracking of offer redemption for the financial institution. The redemption may be stored as part of the customer's profile and input into the financial institution's systems.

Exemplary embodiments may allow for smart queuing of customers. The interface may communicate with one or more websites associated with the financial institution. Through this communication (and thus exchange of data), a customer may perform actions on the website pertaining to their accounts and those actions may be recorded and sent to the interface for display to the user. For example, a customer may set-up an appointment at a branch to discuss a mortgage or loan. This information, along with the customer's profile, may be transmitted to the system of exemplary embodiments. When the customer enters the branch, they may be flagged and the appropriate person alerted through the interface to proceed to assist them. In other embodiments, the customer may conduct a particular transaction on a website or view a particular offer. Upon their next visit to the branch, this information may be available to branch personnel to enable to customer to be provided with service relating to that transaction or the offer viewed by the customer.

In some embodiments, the customer may be able to create a task or action item themselves using a website and then have that task forwarded to a specific branch at which the customer desires to have the task or action completed at. For example, the customer may create a task that they need a replacement debit card and wish to obtain the card at their local branch. The customer may indicate a time they wish to pick-up the card. The task may be submitted via the website. The local branch may receive this task and it may be transmitted to the systems according to exemplary embodiments. The branch may then take appropriate action to procure the replacement debit card to meet the time indicated by the customer. When the customer arrives at the branch, the customer may then be quickly and efficiently helped and the task completed.

The tools 310 may provide resources regarding products and services offered by the financial institution and the status thereof in the particular branch. Sales activity may be accessible through the tools 310. The information may be both real time and historical. This icon may provide information for customer interaction regarding possible sales opportunities of services to customers. Key metrics may be tracked and displayed such as, for example, account information (new, closed net), balances, customer experience/satisfaction, and campaign performance. Shop performance metrics such as branch asset stability and staff optimization may be available. Sales and coaching tools may be displayed to enable adherence to policies and procedures, audit checklists and monitoring, and daily notifications.

The tools 310 may allow access to Policy & Procedures (P&P); Product Reference Guides (PRG); Internal Control Self Check (ICSC)—check lists used; and various “How to” tutorials, such as, e.g., replenishing of supplies for an Instant Issue Device or other financial services device.

The tools 310 may enable fraud and security monitoring. Monitoring of security cameras both inside and outside of the branch may be enabled. Local news feeds may be monitored. Alerts may be conveyed throughout the financial institution by the financial institution regarding emergencies or other activity that may cause an issue for the branch. The alerts may enable the branch personnel to take appropriate action in advance of the emergency. Thus, the system may provide for dissemination of information to all or a subset of branches of the financial institution directly to management personnel. For example, a security camera feed may show an approaching violent demonstration on the street outside the branch. A local news feed may be monitored also to provide such information. The tools 310 may enable the locking of doors and lowering of security curtains in response to protect the branch. This alert information, as well as the actions taken, may be recorded by the system and broadcast to other portions of the financial institution.

Procedures for the actions for various emergency situations may be provided. The tools 310 may enable shutdown of various systems and assets at the branch to prevent harm or damage.

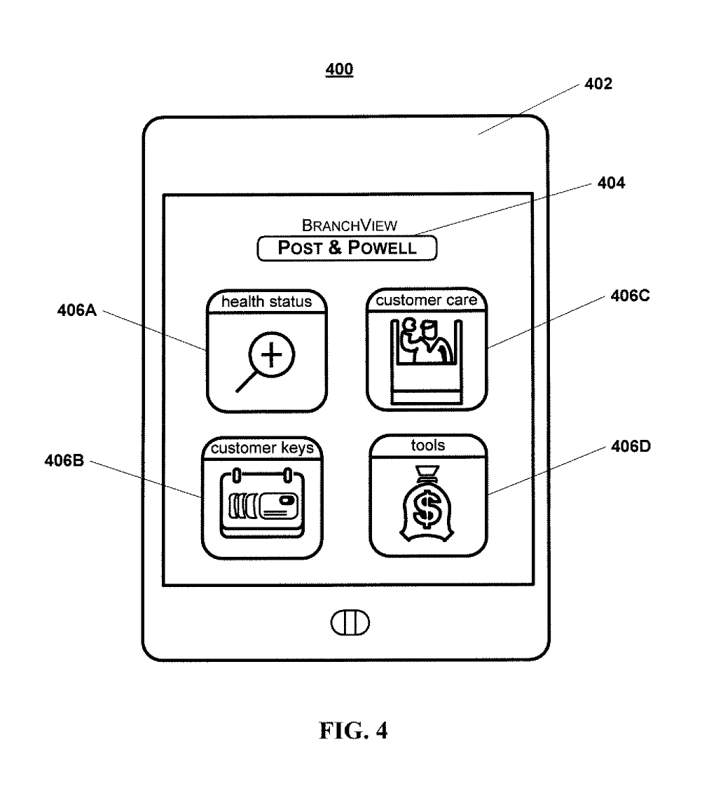

FIGS. 4 through 8 depict interfaces according to exemplary embodiments. As described herein, each of these interfaces may be displayed on a computing device according to exemplary embodiments. These interfaces may be displayed following a selection of an option from a home screen interface as described above. The computing device may be any type of computing device. For example, as depicted in FIGS. 4 through 8, the computing device may be a portable computing or electronic device such as, for example, a tablet computing device. The depiction of the interfaces according to exemplary embodiments on a tablet computing device is meant to be non-limiting. In other embodiments, the interface may have a similar appearance and layout on other types of computing devices, such as, for example, a desktop computer. It should be appreciated that interaction with the interface may vary between different computing devices because of different interaction mechanisms. For example, a tablet computing device may have a touch screen interface and allow selection of options and entry of data to be performed by touching the display screen, whereas on a desktop computer, interaction may be way of a pointing device or cursor operated by a mouse or touchpad, for example. A combination of interaction mechanisms may be used. However, operation of the interface may be the same across computing platforms according to exemplary embodiments.

FIG. 4 depicts an interface 400 on a computing device 402. For example, the computing device 402 may be a tablet computing device. The computing device 402 may be portable such that it may be taken to different locations. The interface 400 may change based on its particular location. The location of the computing device 402 may be sensed by the interface 400 through its GPS location or network connection, for example. In some embodiments, a location may input into the interface 400.

The interface 400 may have a title area 404. The title area 404 may provide the name of the branch location for which the interface 400 is tied to. The title area 404 may therefore change depending on the location of the computing device 402.

The interface 400 may have a series of options 406A, B, C, and D. For example, the interface 400 may have four options: health status 406A, customer keys 406B, customer care 406C, and tools 406D. It should be appreciated that the interface 400 may have more or less options than shown in FIG. 4. It should further be appreciated that not all options may be available at all locations that the computing device 402 is located at. Different options may be displayed at different locations. In some embodiments, the layout, configuration, and data displayed in each interface selected by each icon may vary. These options 406A-D may be selectable by a user of the interface 400. Upon selection of a particular option, a subsequent interface may be displayed. Furthermore, the option icons represented in FIGS. 4-8 are meant to be exemplary and non-limiting as other icon representations may be used for the options 406A, B, C, and D.

Each option 406A, B, C, and D may have indicators that appear to indicate an alert or action is present in that option or that new data has been added to the option. These indicators may appear as a pop-up icon or a color change in the option symbol. A pop-up counter may appear with the number of new alerts or updates that are present. These indicators may be dynamic and change in real-time.

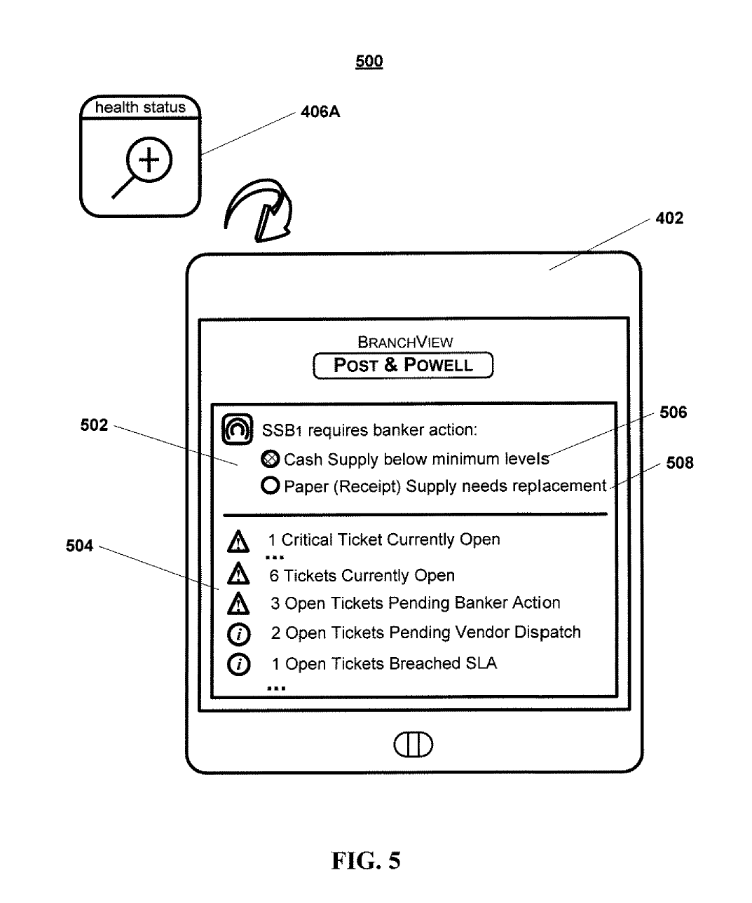

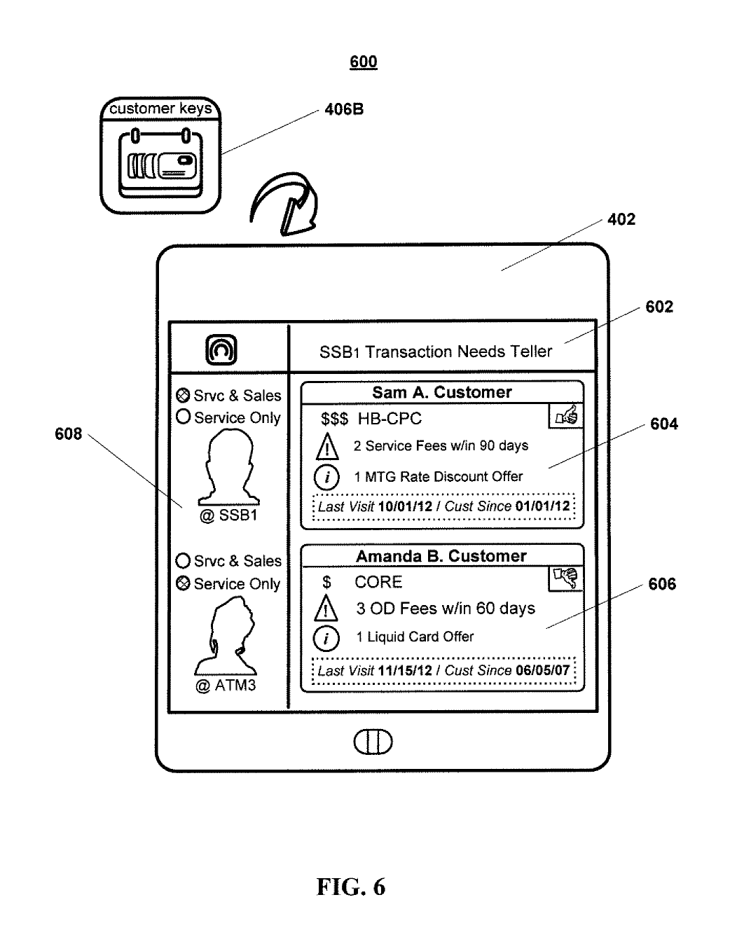

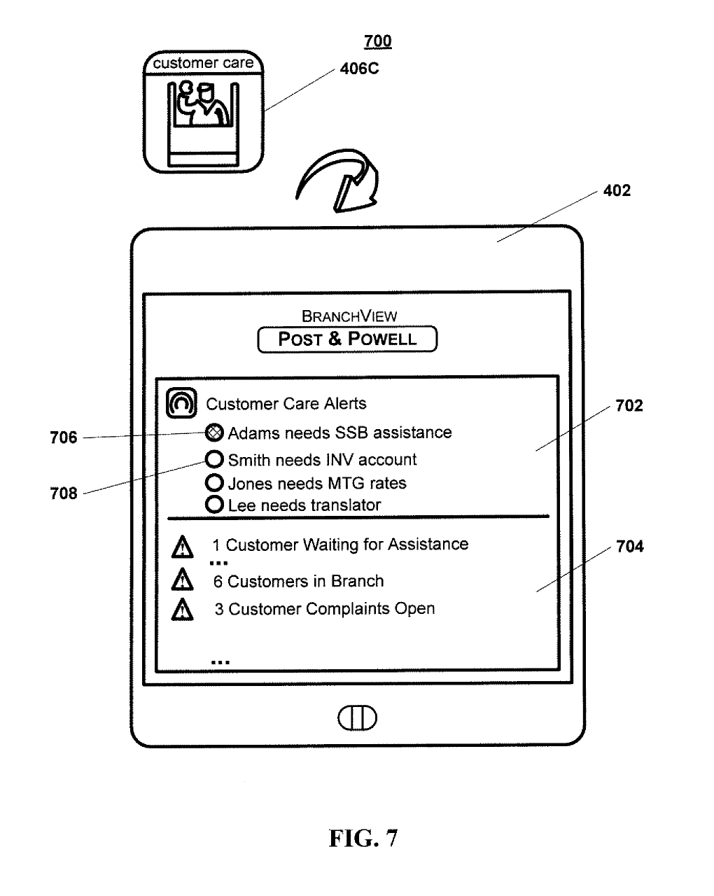

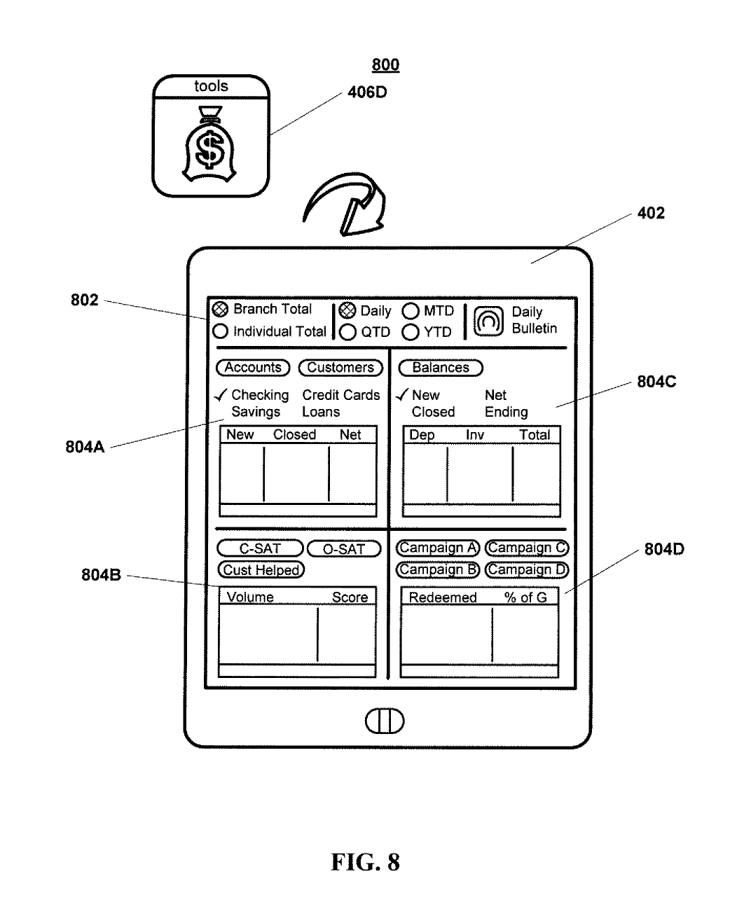

FIGS. 5 through 8 depict such subsequent interfaces according to exemplary embodiments. FIG. 5 depicts an interface 500 that is displayed following the selection of option 406A. FIG. 6 depicts an interface 600 that is displayed following the selection of option 406B. FIG. 7 depicts an interface 700 that is displayed following the selection of option 406C. FIG. 8 depicts an interface 800 that is displayed following the selection of option 406D.

The interface 500 may display the health status of branch equipment. The interface 500 may have an alert area 502 that displays items for action. The interface 500 may have a summary area 504 that provides a summary of equipment action items, such as deficiency reports and/or trouble tickets. The information displayed may be color coded based on criticality or action needed and/or a dot or bullet indicator may be used that differs for different items and is also color coded or is a particular symbol. For example, red may be used for critical items requiring immediate action. The item 506 may be displayed in red while the item 508 may be yellow. As depicted in FIG. 5, each item 506 and 508 may have a different bullet symbol. The items displayed may change color and bullet symbol over time if no action is taken. The information displayed, such as items 506 and 508, may be displayed in a prioritized order, with the higher priority item above the lower priority item(s).

Each item on the interface 500, such as those items in the areas 502 and 504, may be selectable. Upon such selection, details on the selected item may be displayed. For example, the item 506 may be selected and a new window may open or pop-up providing further details of the item. Items may be manually cleared from the alerts area 502 on the interface 500. In other embodiments, the item may clear automatically once appropriate action is taken. To that end, the alerts and information on the interface 500 may by be dynamic in nature and may be displayed based on gathered/reported information from the various equipment and assets in the branch. The equipment and assets in the branch may be connected to a computer network and may self-report their status and any alerts. These alerts may be processed by the system according to exemplary embodiments and communicated with the computing device 402.

The interface 600 may display customer keys information. The interface 600 may provide customer profile information for customers in the branch. This information may be automatically provided based on the customers presently using the branch and conducting business therein. The information may be updated from the customer logging into a financial services device or interfacing with a teller. The information may be obtained from customer check-in based on smart phone apps/RFID/NFC chips, geo-fencing, indoor sensors detecting the customers smart phone or portable electronic device, and/or biometrics. The interface 600 may have a series of areas 602, 604, 606, and 608 that display the profile information. The user of the computing device 402 may there be provided relevant customer information at a glance that is prioritized and relevant. The information provided may include the banking or business segment the customer is associated with, a customer experience/review indicator, what fees the customer has incurred recently, a key/relevant offer for the customer, the last visit, how long the customer has been with the financial institution, customer preferences, outstanding offers made to the customer, and the primary location the customer uses for transactions. This information can be seen on the interface 600. The location of the customer in the branch may be displayed in area 608. In displaying this information about the customer, the interface 600 may provide intelligence to enable a user (such as, for example, a branch manager) to better assist a customer by identifying the customer's problem areas. For example, by identifying recent incurred fees (as shown in FIG. 6), the customer can be provided with advice on how to avoid such fees in the future. Additionally, for example, by identifying a key or relevant offer for the customer, the customer can be provided more details about that offer and any questions can be answered. The key or relevant offer may be made based on an analysis of the customer's profile and past behavior. Thus such an offer may be targeted to the customer.

The interface 700 may display customer care information. This information may be based on customers located in the branch conducting business. The information may be obtained in similar manners to those described above for the interface 600. The interface 700 may provide alerts to customers needing immediate assistance and what those needs are. The interface 700 may have an alert area 702 and a summary area 704. The information displayed may be color coded based on criticality or action needed and/or a dot or bullet indicator may be used that differs for different items and is also color coded or is a particular symbol. For example, red may be used for critical items requiring immediate action. The item 706 may be displayed in red while the item 708 may be yellow. As depicted in FIG. 7, each item 706 and 708 may have a different bullet symbol. The items displayed may change color and bullet symbol over time if no action is taken.

Each item on the interface 700, such as those items in the areas 702 and 704, may be selectable. Upon such selection, details on the selected item may be displayed. For example, the item 706 may be selected and a new window may open or pop-up providing further details of the item. Items may be manually cleared from the alerts area 702 on the interface 700. In other embodiments, the item may clear automatically once appropriate action is taken. To that end, the alerts and information on the interface 700 may by be dynamic in nature and may be displayed based on gathered/reported information from branch and the customer's therein.

The information in the interface 700 may be transmitted from other computing devices 402 within the branch or located elsewhere. The information may be transmitted from other computers on the computer network within the branch. For example, the alerts may be transmitted from a teller's computing device.

The interface 800 may provide tools. The interface may provide access to sales activity information. The sales activity may be gathered from the branch of the financial institution. Other levels of sales activity may be provided. The data displayed may be dynamically updated in real-time. The area 802 may provide the type of sales activity displayed, such as whether it is branch or individual total as well as the time period for the data. The areas 804A, B, C, and D provide the specific sales data and/or metrics. It should be appreciated that the contents of the interface 800 may be customized to represent a variety of different sales data. The interface 800 and its contents 804A, B, C, and D are meant to be exemplary only. The data displayed in the areas 804A, B, C, and D may be selectable to provide further details. That is, each area 804A, B, C, and D may be selectable to provide further details. Another window may be displayed upon such selection.

The interface 800 tools may provide access to other information such as Policy & Procedures (P&P); Product Reference Guides (PRG); Internal Control Self Check (ICSC)—check lists used; and various “How to” tutorials, such as, e.g., replenishing of supplies for an Instant Issue Device or other financial services device. Other information and data may be provided.

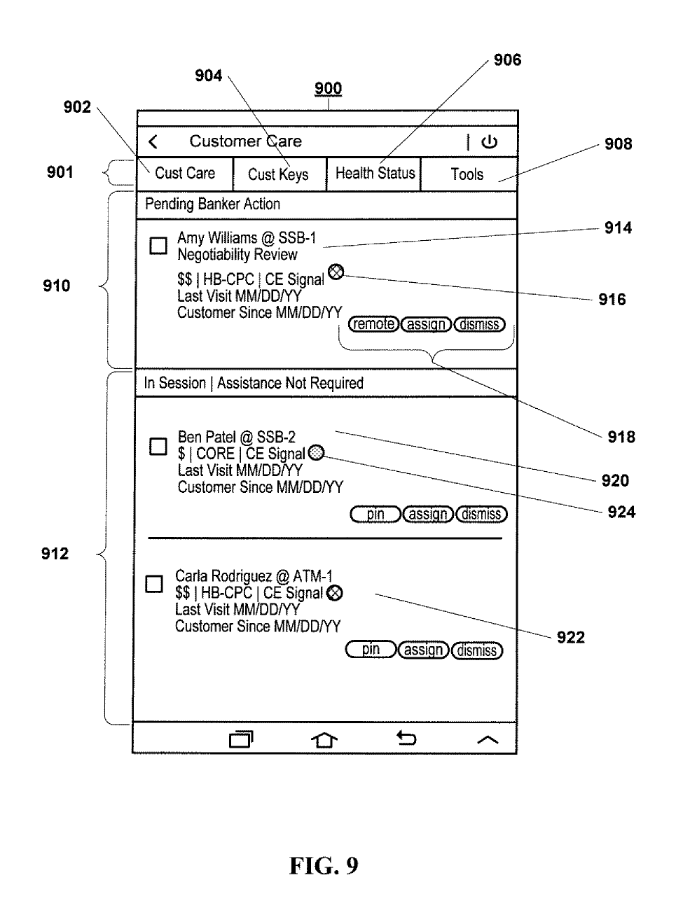

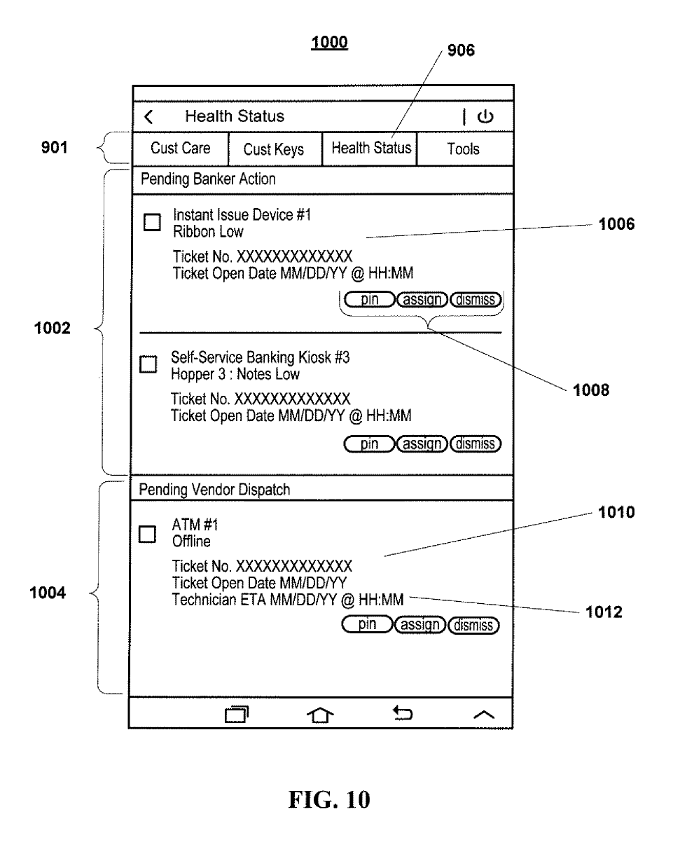

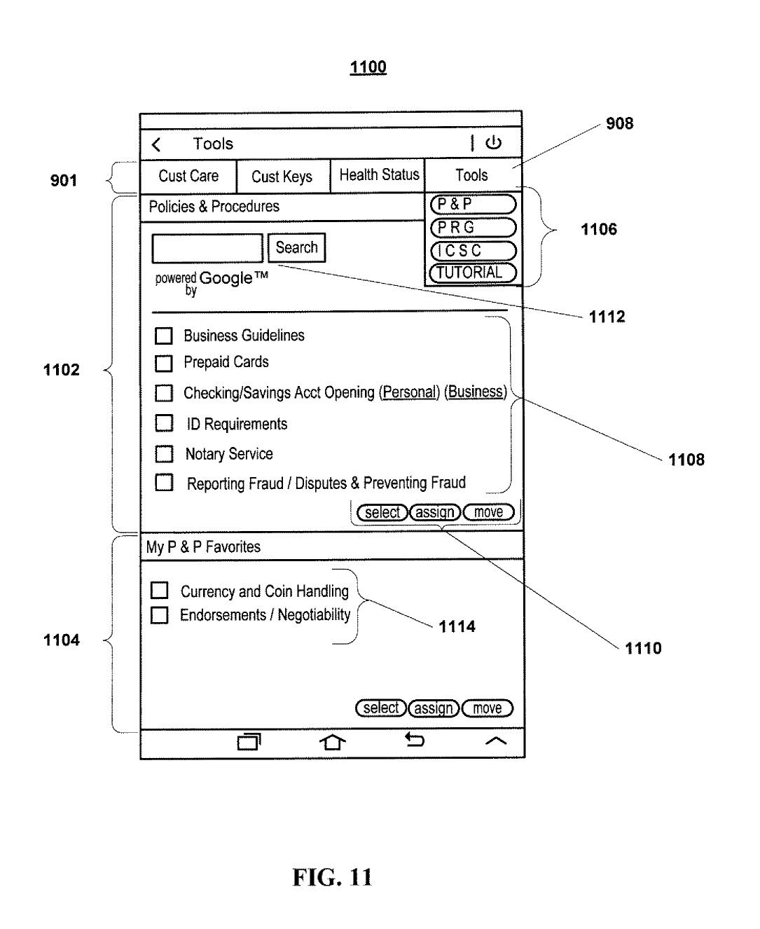

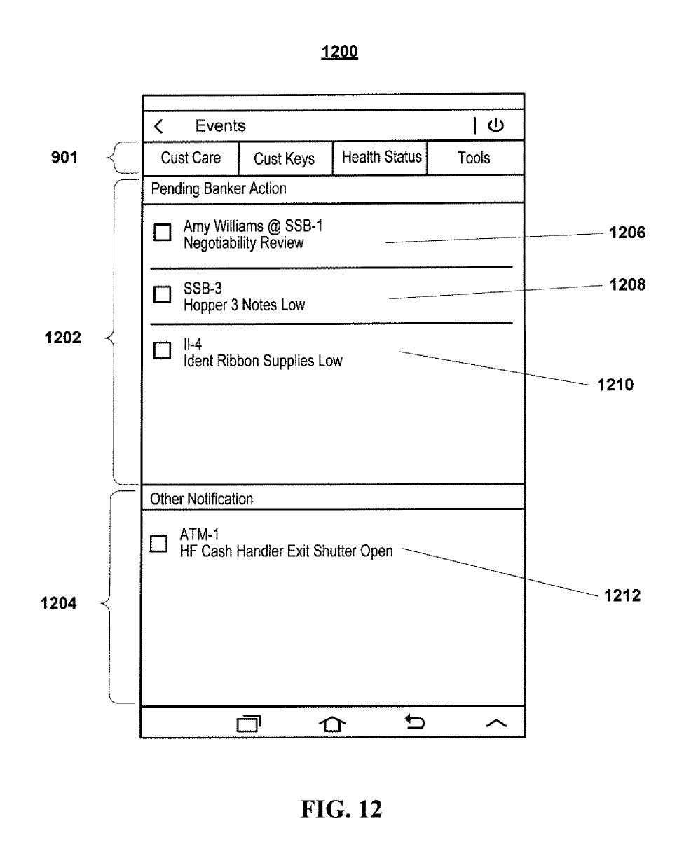

FIGS. 9 through 12 depict interfaces according to exemplary embodiments. FIG. 9 depicts an interface 900. FIG. 10 depicts an interface 1000. FIG. 11 depicts an interface 1100. FIG. 12 depicts an interface 1200. These interfaces may be used with the interfaces described above. In some embodiments, these interfaces may be used in place of the interfaces described above. Thus, the interfaces depicted in FIG. 9 through 12 may be used with the systems and methods described herein.

The interface 900 may have a selection bar or toolbar 901. The selection bar 901 may include options 902, 904, 906, and 908. Selection of one of these options, may cause the interface display to alter. The selection bar may be displayed at the top of each display; that is, it may always be present no matter what information is displayed below it. Stated differently, it may be a fixed menu bar. It should be appreciated that although the selection bar is depicted at the upper portion of the interface 900, it may be located at other positions thereon. In some embodiments, it may be dropped and dragged to other locations by a user.

The interface 900 may have two display areas 910 and 912. These display areas may display information for the user. The information displayed may be updated in real time during use of the interface 900. The display areas 910 and 912 may display alerts and key customer information.

At 914, an alert is depicted for a customer requiring assistance at a self-service device. As part of the alert, a customer experience signal 916 is displayed. At 918, the user is provide a series of options as shown to assist the customer. The options 918 may be tailored to provide assistance to the customer while they are at the financial services device. The alert 914 may be selectable. For example, the box to the left of the alert may be checked or the name of the alert itself may be actuated or interacted with. The series of options at 918 may be applied following this selection. As shown in FIG. 9, there may be three options at 918: remote, assign, and dismiss. Other options may be used. More or less than three options may be available.

The remote option may allow the mobile device user to remote into the session at the financial services device to perform actions, such as those the customer may perform plus additional management actions. The user may be able to override a problem. For example, a customer may have a problem with a transaction at a financial services device making a deposit. The interface may display the appropriate alert as described above. The user may approach the customer and the financial services device and actuate the remote option. The user may then be presented with an appropriate interface to assist the customer complete the transaction.

Assign may allow assignment to another user. A drop-down menu may appear when assign is selected to identify other users to assign the alert or problem to. The alert may then be pushed to that user's mobile device or other computing device.

The dismiss option may allow the alert to be dismissed. The dismissal may move the alert from the display area 910 to the display area 912.

At 920 and 922, other alerts are shown. However, these are in section 912, which shows they do not require assistance. Each of these alerts may have a similar format to that shown above for the display area 910. For example, the alert 920 may have a customer experience indicator 924.

The customer experience indicator 916 and 924 may be used to indicate the status of the customer. The indicator may have a color associated with it to indicate the status. For example, “red” may indicate that the customer has an outstanding issue and “blue” may mean the issue is not outstanding or critical. Other colors may be used to represent additional statuses. In FIG. 9, it can been seen that the indicators 916 and 924 are filled differently to represent different status. In some embodiments, instead of color another visual representation may be used. The experience indicator may be a selectable icon such that clicking or otherwise interacting with the icon may provide additional information related to the indicator.

This indicator may be an internal indicator that is for use by branch personnel only. In some embodiments, it would not be shared with the customer. In some embodiments, it may be updated through the interface following interaction with the customer. It should be appreciated that this indicator may be used on the other interface embodiments described herein. It should further be appreciated that this indicator may be used for assets to indicate a status.

The customer keys option 904 may be a similar interface to the interface 900. The customer keys option may have information displayed similar to the depicted in the interface 600 of FIG. 6, as described above, in a format similar to that of the interface 900.

The interface 1000 may have the selection bar 901 as described in FIG. 9. The interface 1000 may have two display areas 1002 and 1004. These display areas may display information for the user. The information displayed may be updated in real time during use of the interface 1000. The interface 1000 may be the display that is shown when the option 906 is selected; the interface 1000 may be the health status display or board. In some embodiments, the interface 1000 may be a home or default screen that appears first prior to any selections after the system is started and logged into as described above. The display areas 1002 and 1004 may display alerts and key health status of information of various assets.

At 1006, an alert is depicted for regarding an action needed at a self-service device. At 1008, the user is provide a series of options as shown to assist the customer. The alert 1006 may be selectable. For example, the box to the left of the alert may be checked or the name of the alert itself may be actuated or interacted with. The series of options at 1008 may be applied following this selection. The options 1008 may be tailored to provide actions for assignment of the alert to another resource. As shown in FIG. 10, there may be three options at 1008: pin, assign, and dismiss. Other options may be used. More or less than three options may be available.

The assign and dismiss options may function as described above with respect to FIG. 9 at 918. The pin option may allow a user to save the alert on the interface for monitoring. As described above, the information displayed may be updated in real time; thus, pinning the alert or notification on the interface may allow for monitoring overtime of the status of the alert or notification. For example, when a health status alert pops up (e.g., an ATM in the drive-up needs a technician) that branch personnel cannot necessarily take action on for a certain reason (e.g., the alert indicates an issue beyond the capability of branch personnel), the branch manager or other branch personnel would desire to monitor the alert until it is resolved.

At 1010, an alerts regarding a pending vendor dispatch is shown. The estimated arrival time or ETA 1012 of the technician may be shown.

The interface 1100 may have the selection bar 901 as described in FIG. 9.

The interface 1100 may have two display areas 1102 and 1104. These display areas may display information for the user. The information displayed may be updated in real time during use of the interface 1100. The interface 1100 may be the display that is shown when the option 908 is selected; the interface 1100 may be the tools display or board. In some embodiments, the interface 1100 may be a home or default screen that appears first prior to any selections after the system is started and logged into as described above. The display areas 1102 and 1104 may display key tool selections.

Upon option 908 being selected, a drop down menu 1106 may appear. The drop down menu 1106 may have a series of selectable options. Each option may cause the interface 1100 to change and the display areas 1102 and/or 1104 may change in response. For example, the selectable options may include “P&P,” “PRG,” “ICSC,” and “Tutorial.”

The interface 1100 depicts an exemplary embodiment of the P&P menu selection. It should be appreciated that the other menu selections may have similar layouts and options presented to the user in the interface 1100. The display area 1102 presents a series of options relating the menu selection. The display area 1102 may contain the most frequently searched or used options for this menu selection.

In the display area 1102, a series of options 1108 are presented and a series of actions 1110. Each option is selectable. For example, the box to the left of each option may be checked or the name of the option itself may be actuated or interacted with. Upon selection of a specific option, a subsequent interface may be displayed. The actions 1110 may be used to select an option following highlighting or checking of the option. A keyword search area 1112 may be provided to allow searching across the entire spectrum of available information for the selected menu item.

The display area 1104 presents an area for a personalized display of options 1114. The user may therefore customize this display area 1104. The options may be added to this area through one of the actions 1110 following selection of an option in the display area 1102. For example, one of the actions 1110 may be a move option. This may allow for moving the selected option into the display area 1104.

The interface 1200 may have a selection bar or toolbar 901 as described above. The interface 1200 may have two display areas 1202 and 1204. These display areas may display information for the user. The information displayed may be updated in real time during use of the interface 1200. The interface 1200 may be a home or default screen that appears first prior to any selections after the system is started and logged into as described above. The display areas 1202 and 1204 may display alerts and key customer information that is pending and awaiting action.

At 1206, 1208, 1210, and 1212 alerts and notifications are shown. These may be a summary of the alerts and notifications present on the other options from the selection bar 901 and as depicted in FIGS. 9 through 11. Each of these alerts/notifications 1206, 1208, 1210, and 1212 may be selected as is described above for the other interfaces according to exemplary embodiments. In some embodiments, selections of an alert on the interface 1200 may bring up the interface corresponding to the alert/notification category. For example, selection of the alert 1208 may bring up the health status interface 1000 as described above with respect to FIG. 10. In some embodiments, pinned alerts (as described above in FIG. 10) may appear on the interface 1200.

The interfaces shown in FIGS. 4 through 8 may represent interfaces for a particular type of portable electronic device. For example, those interfaces may be used with tablet computing devices. The interfaces shown in FIGS. 9 through 11 may be used with a particular type of portable electronic device. For example, those interfaces could be used with smart phone type portable electronic devices. According to some embodiments, the interfaces may be configured for use with different types of electronic devices based on screen size.

Hereinafter, aspects of implementation of the inventions will be described. As described above, the method of the invention may be computer implemented as a system. The system of the invention or portions of the system of the invention may be in the form of a “processing machine,” for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

The description of exemplary embodiments describes servers, portable electronic devices, and other computing devices that may include one or more modules, some of which are explicitly depicted in the figures, others are not. As used herein, the term “module” may be understood to refer to executable software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices (e.g., servers) instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, portable electronic devices, client devices, computers, etc.) separately. The functions described as being performed at various components may be performed at other components, and the various components may be combined and/or separated. Other modifications also may be made.

According to exemplary embodiments, the systems and methods may be computer implemented using one or more computers, incorporating computer processors. The computer implementation may include a combination of software and hardware. The computers may communicate over a computer based network. The computers may have software installed thereon configured to execute the methods of the exemplary embodiments. The software may be in the form of modules designed to cause a computer processor to execute specific tasks. The computers may be configured with hardware to execute specific tasks. As should be appreciated, a variety of computer based configurations are possible.

The processing machine described above may also utilize any of a wide variety of other technologies including a special purpose computer, a computer system including a microcomputer, mini-computer or mainframe for example, a programmed microprocessor, a micro-controller, a PICE (peripheral integrated circuit element), a CSIC (Customer Specific Integrated Circuit) or ASIC (Application Specific Integrated Circuit) or other integrated circuit, a logic circuit, a digital signal processor, a programmable logic device such as a PLD, PLA or PAL, or any other device or arrangement of devices for example capable of implementing the steps of the process of the invention.

It is appreciated that in order to practice the method of the invention as described above, it is not necessary that the processors and/or the memories of the processing machine be physically located in the same geographical place. For example, each of the processors and the memories and the data stores used in the invention may be located in geographically distinct locations and connected so as to communicate in any suitable manner. Additionally, it is appreciated that each of the processor and/or the memory and/or data stores may be composed of different physical pieces of equipment. Accordingly, it is not necessary that the processor be one single piece of equipment in one location and that the memory be another single piece of equipment in another location. For example, it is contemplated that the processor may be two or more pieces of equipment in two or more different physical locations. These two or more distinct pieces of equipment may be connected in any suitable manner. Additionally, the memory may include two or more portions of memory in two or more physical locations. Additionally, the data storage may include two or more components or two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions. It is also appreciated that the data storage performed by two distinct components as described above may, in accordance with a further embodiment of the invention, be performed by a single component. Further, the data storage performed by one distinct component as described above may be performed by two distinct components.

Further, various technologies may be used to provide communication between the various processors and/or memories, as well as to allow the processors and/or the memories of the invention to communicate with any other entity; e.g., so as to obtain further instructions or to access and use remote memory stores, for example. Such technologies used to provide such communication might include a network, such as a computer network, for example, the Internet, Intranet, Extranet, LAN, or any client server system that provides communication of any capacity or bandwidth, for example. Such communications technologies may use any suitable protocol such as TCP/IP, UDP, or OSI, for example. It should be appreciated that examples of computer networks used in the preceding description of exemplary embodiments, such as the Internet, are meant to be non-limiting and exemplary in nature.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming or any other suitable programming form. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. For example, written lines of programming code or source code, in a particular programming language, are converted to machine language using a compiler, assembler or interpreter. The machine language is binary coded machine instructions that are specific to a particular type of processing machine, e.g., to a particular type of computer, for example. The computer understands the machine language.

Any suitable programming language may be used in accordance with the various embodiments of the invention. Illustratively, the programming language used may include assembly language, ActionScript, Ada, APL, Basic, C, C++, C#, COBOL, Ceylon, Dart, dBase, F#, Fantom, Forth, Fortran, Go, Java, Jquery, Modula-2, .NET, Objective C, Opa, Pascal, Prolog, Python, REXX, Ruby, Visual Basic, X10, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, e.g., the software for example, that enables the computer operating system to perform the operations described above may be contained on any of a wide variety of computer readable media, as desired. Further, the data for example processed by the set of instructions might also be contained on any of a wide variety of media or medium. For example, the particular medium, e.g., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, e.g., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

While the embodiments have been particularly shown and described within the framework of financial services, it will be appreciated that variations and modifications may be effected by a person of ordinary skill in the art without departing from the scope of the invention. Furthermore, one of ordinary skill in the art will recognize that such processes and systems do not need to be restricted to the specific embodiments described herein. Other embodiments, combinations of the present embodiments, and uses and advantages of the present invention will be apparent to those skilled in the art from consideration of the specification and practice of the invention disclosed herein. The specification and examples should be considered exemplary.

1.-12. (canceled)

13. A computer implemented method, comprising:
receiving, by a portable electronic device, an alert indicating the entry of a customer into a branch office of a financial institution, wherein the portable electronic device is located within the branch office of the financial institution;
receiving, by the portable electronic device, real time data associated with the indicated customer indicating the presence of the indicated customer within the branch office of the financial institution;
receiving, from one or more asset monitoring systems, additional real time data associated with the operational health and/or readiness of one or more assets located inside of the branch office of the financial institution;
transmitting, by the portable electronic device, the real time data to one or more servers;
transmitting, by the one or more asset monitoring systems, the additional real time data to one or more servers;
providing, by at least one computer processor of the portable electronic device, an electronic user interface on a computing device, wherein the electronic user interface comprises a first screen comprising at least one option and the interface is tailored to the financial institution;
receiving, by the at least one computer processor of the portable electronic device, a selection of an option from the at least one option on the first screen;
providing, by the at least one computer processor of the portable electronic device, a second screen in response to the selection of the option;
receiving, from the one or more servers, the real time data associated with the indicated customer and the additional real time data associated with the operational health and/or readiness of one or more assets located inside of the branch office of the financial institution based on the selection of the option wherein the real time data associated with the indicated customer further relates to the operation of the branch of the financial institution based on the option;
processing, by the at least one computer processor of the portable electronic device, the real time data associated with the indicated customer, the processing causing the real time data associated with the indicated customer to be displayed on the second screen;
receiving, by the at least one computer processor of the portable electronic device, an assistance alert identifying the indicated customer as requesting assistance at the portable electronic device; and
processing, by the at least one computer processor of the portable electronic device, the assistance alert and the real time data associated with the indicated customer to determine a customer status based on the assistance alert, the processing causing the customer status and one or more options for providing assistance to the indicated customer to be displayed on the second screen wherein the one or more options for providing assistance comprise: initiating a remote session with the one or more assets associated with the indicated customer wherein the remote session includes control or modification of the one or more assets, assigning the assistance alert to another computing device, and dismissing the assistance alert.

14. (canceled)

15. The method of claim 13, wherein the portable electronic device comprises one of: a smart phone and a tablet computing device.

16. The method of claim 13, wherein the at least one option comprises one or more of the following: health status, customer care, customer keys, and tools.

17. The method of claim 13, further comprising:
dynamically updating the real time data associated with the indicated customer and displaying the updated real time data associated with the indicated customer.

18. The method of claim 13, wherein processing the assistance alert further comprises displaying, electronically, at the computing device, a profile and a service request associated with the indicated customer.

19. The method of claim 13, further comprising:
receiving, electronically, an electronic communication comprising the real time data associated with the indicated customer from a second computing device associated with the indicated customer.

20. The method of claim 19, wherein the second computing device associated with the indicated customer is a portable electronic device.

21. The method of claim 20, wherein the portable electronic device comprises one of: a smart phone and a tablet computing device.

22. A system, comprising:
a financial services device, wherein the financial services device is located within a branch office of a financial institution, configured to:
receive an alert indicating the entry of a customer into the branch office of the financial institution;
receive real time data associated with the indicated customer indicating the presence of the indicated customer within the branch office of the financial institution; and
transmit the real time data to one or more servers;
one or more asset monitoring systems, configured to:
receive additional real time data associated with the operational health and/or readiness of one or more assets located inside of the branch office of the financial institution; and
transmit the additional real time data to the one or more servers;
a computing device, communicatively coupled to the financial services device, wherein the computing device comprises:
a processor; and
a memory, communicatively coupled to the processor, the memory comprising computer-readable instructions which when executed by the processor cause the processor to perform the steps comprising:
providing an electronic user interface on the computing device, wherein the electronic user interface comprises a first screen comprising at least one option and the interface is tailored to the financial institution;
receiving a selection of an option from the at least one option on the first screen;
providing a second screen in response to the selection of the option;
receiving, from one or more servers, the real time data associated with the indicated customer and the additional real time data associated with the operational health and/or readiness of one or more assets located inside of the branch office of the financial institution based on the selection of the option wherein the real time data associated with the indicated customer further relates to the operation of the branch of the financial institution based on the option;
processing the real time data associated with the indicated customer, the processing causing the real time data associated with the indicated customer to be displayed on the second screen;
receiving an assistance alert identifying the indicated customer as requesting assistance at the financial services device; and
processing the assistance alert and the real time data associated with the indicated customer to determine a customer status based on the assistance alert, the processing causing the customer status and one or more options for providing assistance to the indicated customer to be displayed on the second screen wherein the one or more options for providing assistance comprise: initiating a remote session with the one or more assets associated with the indicated customer wherein the remote session includes control or modification of the one or more assets, assigning the assistance alert to another computing device, and dismissing the assistance alert.

23. The system of claim 22, wherein the computing device comprises a portable electronic device.

24. The system of claim 23, wherein the portable electronic device comprises one of: a smart phone and a tablet computing device.

25. The system of claim 22, wherein the at least one option comprises one or more of the following: health status, customer care, customer keys, and tools.

26. The system of claim 22, wherein the processor further performs the steps comprising:
dynamically updating the real time data associated with the indicated customer and displaying the updated real time data associated with the indicated customer.

27. The system of claim 22, wherein processing the assistance alert further comprises displaying a profile and a service request associated with the indicated customer.

28. The system of claim 22, wherein the financial services device is further configured to:
receive an electronic communication comprising the real time data associated with the indicated customer from a second computing device associated with the indicated customer.

29. The system of claim 28, wherein the second computing device associated with the indicated customer is a portable electronic device.

30. The system of claim 29, wherein the portable electronic device comprises one of: a smart phone and a tablet computing device.

31. (canceled)

32. The method of claim 13, wherein the customer status indicates a current level of assistance required for the indicated customer.
